(19) United States
(12) Patent Application Publication
(10) Pub. No.: US 2004/0148601 A1
(43) Pub. Date: Jul. 29, 2004

(54) Method and system for calculation and use of a disk image identifer

(76) Inventor: James L. Kroening, Dakota Dunes, SD (US)

Correspondence Address: GATEWAY, INC., ATTN: SCOTT CHARLES RICHARDSON, 610 GATEWAY DRIVE, MAIL DROP Y-04, N. SIOUX CITY, SD, 57049, US

(21) Appl. No.: 10/757,257

(22) Filed: Jan. 14, 2004

Related U.S. Application Data
(63) Continuation-in-part of application No. 09/631,081, filed on Aug. 2, 2000.
(60) Provisional application No. 60/499,665, filed on Sep. 3, 2003.

(51) Int. Cl. G06F 9/445

(52) U.S. Cl. 717/177

(57) ABSTRACT

A method of calculating a disk image identifier for use in a software delivery system is disclosed. An order entry process produces a bill of materials (BOM) and a unique software image identification number (USIIN) is calculated therefrom. The USIIN is then added to the BOM. The BOM is sorted into ascending alphanumeric order. The USIIN is generated using a 128-bit hash algorithm on each entry in the BOM until the end. A software delivery process looks for exact image orders and sets a system duplication process in motion where duplicate orders of images will generate the same USIIN and be cached for future use in the software delivery process as required.

### CROSS REFERENCE TO RELATED APPLCATIONS

The present application is a Continuation-In-Part of co-pending U.S. patent application Ser. No. 09/631,081 entitled “Method for Configuring Software for a Build to Order System”, filed on Aug. 2, 2000, attorney docket number P1236US05 (hereinafter “parent application”) the contents of which parent application is incorporated herein by reference.

### FIELD OF THE INVENTION

The present invention is related to software delivery systems used in the manufacture and delivery of software to computer systems. In particular, the present invention is related to the creation of a disk image identifier for use in delivering software images to disks.

### BACKGROUND OF THE INVENTION

In contrast to manual installation of software on hard drives, image based software installation is preferable for installation of software on computer systems as described in greater detail in the parent application. Modern personal computer manufacturing has evolved to the point where a significant portion of the manufacturing process involves the assembly of components and subcomponents into an individual system and provisioning the system with the appropriate software. The components may include a display device, floppy drives, hard drives, modems, CD-ROM devices, wireless interfaces, and the like. For proper operation, these devices require certain software configurations and drivers to be present.

Hard drives typically further contain “bundled” software including the operating system, configuration files, applications, and drivers for each of the hardware components. It is preferable to provision system hard drives with the aggregate software load or “image” by building and transferring the image from a server or other image storage device, to the target drive automatically rather than relying on the lengthy process of manual installation. As is known to those of skill in the art, a disk image is essentially a digital “picture” of the contents of the drive reducing the software loading process to a streaming transfer of the digital contents of the image to the new drive or drives. Thus, a disk image file, or simply a disk image, is an exact binary copy of an entire disk or drive. Disk image files contain all the data required to be stored on the target drive including not only files and folders but also boot sectors, file allocation tables, volume attributes and any other system-specific data. A disk image is an exact duplicate of the raw data required to be present on the target disk, sector by sector. Since disk images contain the raw disk data, it is possible to create an image of a disk written in an unknown format or even under an unknown operating system. Incremental image loads may also be used to provision systems with upgrades based on a “delta” or difference between a baseline image configurations and a new image configuration.

To the extent that provisioning disks with software images and tracking of various software downloads corresponding to specific hardware configurations must be performed on an individual basis, e.g. based on particular customer orders of one of a number existing configurations, the process becomes increasingly complex. Also, for personal computer manufacturers who operate retail outlets such as, Gateway 2000, Inc., orders may be taken and filled individually based on custom configurations further increasing tracking complexity. Still further, if, for example, a main hard drive fails, e.g. the hard drive containing the main software image, it would be desirable to track the software image originally loaded on the failed drive in order to load that image on the replacement drive or to determine the baseline configuration for the purposes of upgrading the failed drive. Greater economies of scale could further be achieved by grouping and provisioning large numbers of similarly configured systems while maintaining the ability to track and support customers individually.

On one end of the conventional image loading spectrum, systems are provisioned individually to each customer's requirements using a Bill of Materials (BOM). A BOM is typically generated for each order and contains all the parts for the system including software “parts” such as the operating system, the application software, device drivers, registries, CMOS settings, BIOS software, and the like. Problems may arise however, in that when software/hardware configurations are tracked individually it becomes difficult to determine which software load an individual user may have had corresponding, for example, to the specific hardware configuration ordered if the BOM system cannot accurately track software loads.

Some BOM systems, such as that described in U.S. Pat. No. 5,307,261 issued to Maki et al. on Apr. 26, 1994, address the issue of configuration management and tracking by managing lists of end item configurations that may be affected by engineering changes and “as built” configuration requirements. End item configuration identifier lists are managed in Maki for all the possible combinations of items. The identifiers correspond to “products”, e.g. product model, and do not allow for spontaneous changes as the lists are not generated during the order process but rather are already present. In other words, a particular end item configuration must match one of the predefined configurations.

Consequently, it would be desirable to provide a way to generate a unique image identifier for a disk image, the image associated with a desired software configuration. Such an identifier would improve processing and grouping capabilities and could be generated early in the manufacturing process during, for example, the generation of orders.

### SUMMARY OF THE INVENTION

Accordingly, the present invention is directed to a method for identifying a software configuration in an image delivery system preferably having a storage device for storing and retrieving images and image related information. In accordance with various exemplary embodiments, the method preferably comprises processing a component list associated with a system to be built. The component list may contain an essential portion and a non-essential portion, e.g. software related components and non-software related components such as enclosures or the like. A key generating function may then be performed on the essential portion of the component list to generate a key associated with the software configuration, which key may be used to determine if the software configuration exists on the storage device. An image associated with the software configuration may be transferred to one or more target devices if the essential component list associated with each of the one or more target devices produces the same generated key when the key generating function is performed on each essential component list associated with the target devices. A new image associated with the software configuration may be generated if the essential component list fails to produce the generated key. It should be noted that the key generating function may preferably include a 128-bit hash algorithm.

In accordance with other exemplary embodiments, the inventive method may be used for identifying a software configuration in an image delivery system preferably having a storage device for storing and retrieving images and image related information. The method preferably comprises generating a bill of materials associated with a target computer system from an order entry portion of the image delivery system. The bill of materials is preferably divided into an essential portion and a non-essential portion. The essential portion of the bill of materials may be sorted into alphanumeric order, e.g. ascending alphanumeric order, and a key generating function may be performed thereon to generate a key associated with the software configuration, e.g. for identification. The generated key may then be used to determine if the software configuration exists on the storage device. An image associated with the software configuration may then be transferred to one or more target computer system if the essential portion of the bill of materials associated with each of the target computer systems produces the same generated key. A new image associated with the software configuration may be generated if the essential portion of the bill of materials associated with the target computer systems fails to produce the generated key. It should be noted that the key generating function preferably includes a 128-bit hash algorithm and the essential component list preferably includes software-related components.

In accordance with still other exemplary embodiments, the method may be used for identifying a software configuration in an image delivery system preferably having a storage device for storing and retrieving images and image related information. The method preferably comprises generating a bill of materials associated with a target computer system from an order entry portion of the image delivery system. The bill of materials is preferably sorted into alphanumeric order, e.g. ascending alphanumeric order, and a key generating function performed on at least a portion of the bill of materials to generate a key associated with the software configuration, e.g. for identification. The generated key may be used to determine if the software configuration exists on the storage device. An image associated with the software configuration may be transferred to one or more target computer systems if the portion of the bill of materials associated with each of the target computer systems produces the same generated key. An image associated with the software configuration may be generated if the portion of the bill of materials associated with each of the target computer systems fails to produce the generated key. It should be noted that the key generating function preferably includes a 128-bit hash algorithm and the essential component list preferably includes software-related components.

In accordance with additional exemplary embodiments, a computerized system may be used for identifying a software configuration for image delivery. The computerized system comprises a processor, a computer readable medium capable of being read by the processor, and a plurality of computer instructions thereon. The plurality of computer instructions are preferably executable by the processor and cause the processor to generate a bill of materials associated with a target computer system from an order entry portion of the image delivery system. The bill of materials may be sorted into alphanumeric order, e.g. ascending alphanumeric order. A key generating function may be performed on at least a portion of the bill of materials to generate a key associated with the software configuration, e.g. for identification. The generated key may be used to determine if the software configuration exists on the storage device. The instructions may further cause the processor to transfer an image associated with the software configuration to one or more target computer systems if the portion of the bill of materials associated with each of the target computer systems produces the same generated key. A new image associated with the software configuration may be generated if the portion of the bill of materials associated with each of the target computer systems fails to produce the generated key. It should be noted that the key generating function preferably includes a 128-bit hash algorithm and the essential component list preferably includes software-related components.

In accordance with still other exemplary embodiments a computerized system may be used for identifying a software configuration for image delivery. The computerized system preferably comprises a processor, a computer readable medium capable of being read by the processor, and a plurality of computer instructions on the computer readable medium. The plurality of computer instructions are preferably executable by the processor and cause the processor to generate a bill of materials associated with a target computer system from an order entry portion of the image delivery system. The bill of materials may be divided into an essential portion and a non-essential portion. The essential portion of the bill of materials may be sorted into alphanumeric order, e.g. ascending alphanumeric order. A key generating function may be performed on the essential portion of the bill of materials to generate a key associated with the software configuration, e.g. for identification. The generated key may be used to determine if the software configuration exists on the storage device. The instructions may further cause the processor to transfer an image associated with the software configuration to one or more target computer systems if the essential portion of the bill of materials associated with the one or more of the target computer systems produces the same generated key. A new image associated with the software configuration may be generated if the essential portion of the bill of materials associated with each of the target computer systems fails to produce the generated key. It should be noted that the key generating function preferably includes a 128-bit hash algorithm and the essential component list preferably includes software-related components.

In accordance with still other exemplary embodiments, a computerized system may be used for identifying a software configuration for image delivery. The computerized system preferably comprises a processor, a computer readable medium capable of being read by the processor, and a plurality of computer instructions on the computer readable medium. The plurality of computer instructions are preferably executable by the processor and cause the processor to process a component list associated with a system to be built, the component list preferably containing an essential portion and a non-essential portion. A key generating function may be performed on the essential portion of the component list to generate a key associated with the software configuration, e.g. for identification. The generated key may preferably be used to determine if the software configuration exists on the storage device. The instructions may further cause the processor to transfer an image associated with the software configuration to one or more target devices if the essential component list associated with each of the target devices produces the same generated key. A new image associated with the software configuration may be generated if the essential component list associated with each of the one or more target devices fails to produce the generated key. It should be noted that the key generating function preferably includes a 128-bit hash algorithm and the essential component list preferably includes software-related components.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is diagram illustrating an exemplary system for creating and delivering a disk image associated with a desired software configuration in accordance with various exemplary embodiments of the present invention;

FIG. 2A is flowchart illustrating exemplary steps for creating and delivering a disk image associated with a desired software configuration in accordance with various exemplary embodiments of the present invention;

FIG. 2B is block diagram illustrating exemplary calculation of a Configuration ID associated with a desired software configuration in accordance with various exemplary embodiments of the present invention;

FIG. 2C is block diagram illustrating exemplary signature generation associated with a desired software configuration in accordance with various exemplary embodiments of the present invention;

FIG. 2D is block diagram illustrating exemplary processing of a BOM associated with a desired software configuration in accordance with various exemplary embodiments of the present invention; and

FIG. 3 is a diagram of an exemplary disk image and identification associated with a desired software configuration in accordance with various exemplary embodiments of the present invention.

### DETAILED DESCRIPTION OF THE INVENTION

The present invention provides a method and apparatus for calculation and use of a disk image identifier in an exemplary manufacturing or service environment where, for example, original equipment disk drives are provisioned with software loads or replacement disk drives are configured with original images and/or updated images. Reference will now be made in detail to the presently preferred embodiments of the invention, examples of which are illustrated in the accompanying drawings.

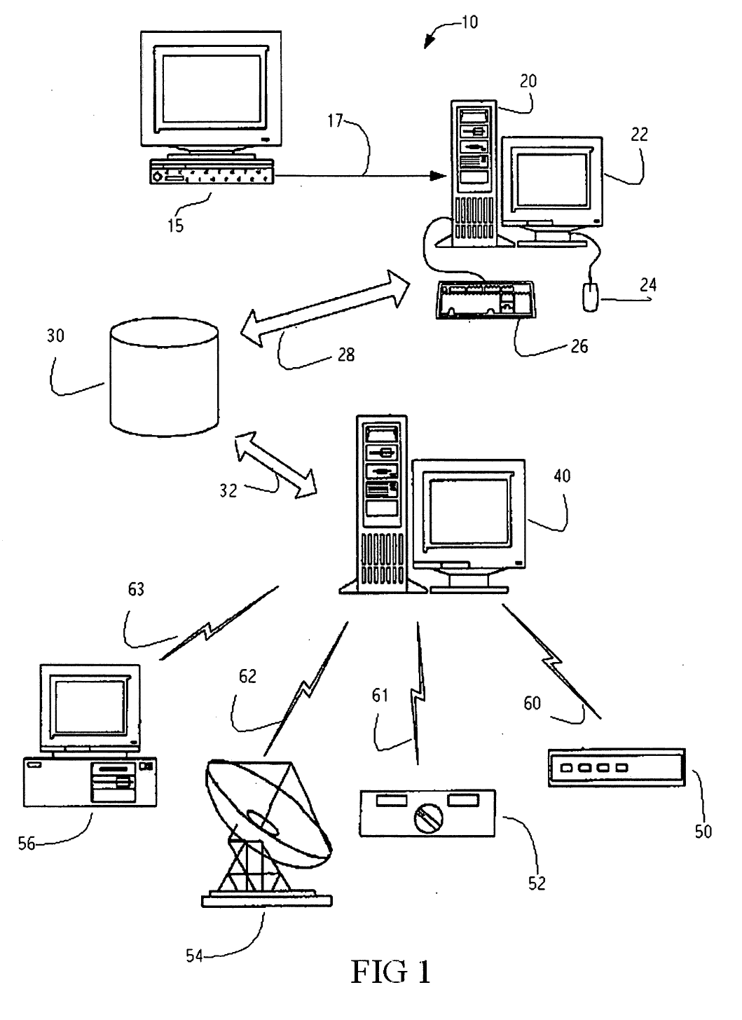

An exemplary system configuration for provisioning, e.g. creating and delivering, a disk image corresponding to a desired software configuration is illustrated in FIG. 1. An exemplary disk image provisioning process may use a collection of components such as computerized network system 10 for creating and delivering custom software configurations defined by purchasing customers during an order entry stage as will be described in greater detail hereinafter. Since the process of provisioning a large number of target systems with software loads and/or updates can be relegated to a relatively high-level task, the disk image can be treated as a large granularity object, and thus intelligent processing thereof may facilitate rapid system provisioning.

Included within computerized network system 10 may be exemplary image builder 20 for creating a disk image of the desired software configuration and transferring the resulting image to exemplary storage device 30. Storage device 30 may be connected to exemplary image server 40 for performing delivery of the created image, for example, directly to exemplary hard drive 50 during manufacturing and assembly of a target computer system. The created image may also be delivered to exemplary disk duplicator 52 (“dupper”) which may be used for duplicating the image, for example, on a computer readable medium. The created image may further be transferred to exemplary ground based transmitter 54 for broadcasting the image, for example, over a satellite link, or to exemplary management information system 56 for loading the image on systems, for example, in a network controlled by management information system 56.

The first step in an exemplary disk image delivery process involves entering a customer's order for a computer system into order entry system 15. The customer order contains hardware and software options desired by the customer and is used to establish a BOM for manufacturing purposes. The generated BOM preferably includes an itemized selection of a customer's desired hardware and software configurations for a particular computer system in a part-number encoded list. The BOM may further be alpha-numerically sorted or normalized such that data entry errors may be quickly identified and rectified. Included within the BOM may be hardware settings and parameters of the computing system associated with a corresponding software and/or driver configuration, including BIOS and CMOS settings plus other pertinent information as may be necessary. Such settings may be used by the image builder in addition to hardware and software application information to create a digital image of the desired software configuration.

In one embodiment, order entry system 15 is preferably a minicomputer or suitable multi-processing system capable of supporting from four to about two hundred users simultaneously. It should be noted that minicomputers are well known to those skilled in the art and in terms of size and power, fall between a desktop workstation and a mainframe. An example of a minicomputer would be, for example, the IBM AS/400 minicomputer. Thus in accordance with various exemplary embodiments of the present invention, a minicomputer may function as exemplary order entry system 15 although equivalent order entry platforms may be acceptable as an alternative to a minicomputer such as a workstation or a mainframe.

As previously described, information included within the BOM may correspond to a particular software configuration desired by a customer, e.g. software applications, BIOS, drivers, and the like, plus specific hardware components of the computing system receiving the software configuration. It should be noted that while the previously described image delivery system of the present invention may preferably be used to provision newly ordered and manufactured systems, the present invention may further be used to provide upgrades to an existing image or portion thereof, e.g. an application, already installed on the computing system. Alternatively, if a new, e.g. replacement, hard drive must be configured with an operating system and a variety of applications, the present invention may be used to track and provision the new hard drive with the original software configuration vis-a-vis the original image.

Once generated and “normalized” as described herein above, the exemplary BOM may be input from order entry system 15 to exemplary image builder 20 over interface 17 using any type of common and/or proprietary interface standards and data transfer standards which are well known in the art such as serial data transfer, or the like. It is further contemplated that the BOM could be input to image builder 20 from a storage medium such as a CD-ROM or even from a telephone or Internet connection from a remote order location such as a retail store or the like. Once exemplary BOM is loaded into image builder 20, an image may either be generated, or an existing cached image may be identified which exactly corresponds to the hardware and software enumerated in the BOM. While images may be cached and re-cached based on demand frequency over time as is well known in the art, the generation of the image and unique image identifier will be described in greater detail herein after.

Intelligence may be provided in the image delivery process through caching. Because exemplary image builder 20 sorts through a database of stored images to first determine if an image of the desired configuration has already been created for a prior computer configuration a cache location can be determined to expedite image creation and/or loading. Previously generated images may be cached and/or stored in longer term memory space on exemplary large capacity storage device 30 or multiple storage devices such as a disk farm or the like. If an image of the desired configuration has not previously been created, image builder 20, particularly in the case of an upgrade, may select an appropriate baseline image from the storage device 30 and then determine which incremental image are to be layered on top of the baseline image to achieve the desired final configuration. Alternatively, the image may be generated from individual software components. It should be noted that incremental images, or “delta” images, preferably contain additional information beyond the baseline image for achieving the desired software configuration. A level of granularity, e.g. an aggregation of many low level processes and/or data into fewer higher level processes and/or data, may thus be achieved because of resulting linear flow process associated with achieving the desired configuration by adding a delta image to a baseline image rather than generating an image from all of the sub components. If a needed delta image is not in the database, then exemplary image builder 20 may construct a necessary delta image which may then be stored for future image builds.

It should be noted that configuration numbers are preferably assigned to all baseline images and delta images, which allows image builder 20 to sort through ail possible images that can be used in the configuration process. Since the exemplary disk image delivery process illustrated in FIG. 1 is a linear process, image builder 20 has the ability to analyze the contents of the data stream as the image is loading on the target computer system hard drive 50. Consequently, exemplary image builder 20 may perform a file by file review of the baseline image, identifying areas of discrepancy and determining what portions of a baseline if any may need to be replaced. File names may be examined not only by name but by creation date. The image builder 20 looks at specific files by a specific name or code at the time of its creation. In lieu of examining the baseline on a file by file basis, a bit by bit comparison may be performed or a unique code may be generated indicative of the content of the BOM as will be described in greater detail hereinafter. In addition to performing comparison tasks, another level of intelligence is obtained when the image builder 20 determines changes to be made, for example, in registry settings and in interrupt settings so that new software configurations will operate properly on the hardware configuration of the target computer system. If the desired software configuration is not compatible with the hardware of the target computer system, then image builder 20 may reject the BOM as a non-functional configuration.

As described, either an entire image including, for example, a newly generated image, a baseline image and a delta image, or, alternatively, just a delta image may be loaded onto an exemplary target computing system. Methods of loading an exemplary image onto a target computer system are well known to those skilled in the art. For example, if an exemplary target computer system's hard drive, such as hard drive 50 depicted in FIG. 1, is currently configured and requires an application upgrade, then only the delta image is installed if available, otherwise it would be created and then installed. However, if hard drive 50 is being configured as a new component of a new target computer system, as, for example, in a manufacturing and assembly process, then an entire image would be installed if available or created and installed if not available. Thus the image delivery process in most cases obviates the need to create a new baseline for every image that is to be delivered. Moreover, image builder 20 may contain editors for determining, for example, proper registry settings and also may add directory information corresponding to installed applications and their file locations. An added benefit of installing delta images on a baseline image is the degree to which such an approach allows technical support personnel and software engineers to more easily isolate problem areas and debug and correct problems as they arise. Because of the degree of granularity, a problem arising after a delta image was overlaid on top of, for example, a baseline image known to be error free, can easily be isolated to the newly added delta image. Once a corrected delta image is created, then the correct image may be installed on the target computer system.

It will be appreciated that image builder 20 preferably includes a computer having a processor, preferably an Intel® Pentium® processor, preferably at least thirty-two megabytes of random-access memory (RAM), read-only memory (ROM), and one or more secondary storage devices, including, for example, a hard disk drive, a floppy disk drive into which a floppy disk can be inserted, an optical disk drive, a tape cartridge drive or other types of computer-readable media. Image builder 20 may preferably be coupled to monitor 22, a pointing device 24, and keyboard 26. It will further be appreciated that while image builder 20 is shown as being a PC style computer system, many types of computers or computer systems can be suitably configured in accordance with the present invention. In one embodiment, image builder 20 may be a typical “PC Compatible” computer running any of the various versions of the Windows® operating system by Microsoft, Inc., of Redmond Wash the construction and operation of which are well known within the art. Monitor 22 permits the display of information for viewing by a user of the computer and can be a CRT, LCD, or any suitable monitor as would be known in the art. Pointing device 24, which includes but is not limited to a mouse, touch pad, trackball, or the like, permits control of the screen pointer associated with the graphical user interface (GUI) of the operating system as in common in GUI-based operating systems such as any of the Windows® operating systems as described above. In one exemplary embodiment, image builder 20 is preferably a Gateway 2000, Inc., desktop personal computer, monitor 22 is preferably a super-VGA CRT display, pointing device 24 is preferably a conventional mouse, and keyboard 26 is preferably a conventional keyboard, for permitting the entry of textual information into image builder 20, as known within the art. Image builder 20 may further be coupled to a storage device 30 which is preferably a large volume storage device via interface 28. Once image builder 20 creates an image and corresponding configuration number, images are preferably stored on storage device 30. Further, as described above, when image builder 20 is creating a disk image associated with an upgrade or the like, storage device 30 may first be surveyed to determine if the desired image configuration or the components sufficient to build the desired image configuration are present either as a combination of delta images and baseline images or software components sufficient to create a new baseline or delta image.

It should be noted that the storage device 30 is not limited to any specific storage format or structure as long as the storage device 30 contains computer-readable media such as electronic memory, magnetic memory, optical memory, capable of being interfaced with. For example, storage device 30 may include one or a family of hard disk drives, one or a series of floppy disk drives into which one or more floppy disks can be inserted, one or more optical disk drives, or one or more tape cartridge drives. It will further be appreciated that storage device 30 may be internal to image builder 20 as, for example, an auxiliary drive or even a primary drive, or may exist as a stand alone device, as illustrated in FIG. 1. After image builder 20 has created an image corresponding to the desired software configuration, and stored the created image on storage device 30, the image may be further transferred to an image server 40 via interface 32. It should be noted that image server 40 may be a computer system similar to image builder 20 and further, that storage device 30 may also be internal to image server 40 in a manner similar to that described above.

Thus, image server 40 may preferably be the point of delivery for the disk image via a variety of interfaces 60-63 as illustrated in FIG. 1. In one illustrative embodiment, image server 40 may be coupled to hard drive 50 via interface 60 which may be, for example, a serial interface, a parallel interface, an infrared interface, a wireless interface or the like. Hard drive 50 may accordingly be configured with an image corresponding to the desired software configuration during manufacturing, e.g. before installation into a target computer system. In another illustrative embodiment, image server 40 may be coupled to disk duplicator 52 or “dupper” via interface 61 where the disk image may be duplicated onto one or more computer readable media such as a floppy disk, a recordable CD, a zip drive or the like. In still another illustrative embodiment, image server 40 may be coupled to ground based transmitter 54 via interface 62 for wireless transmission of the disk image to an end user or system. Depending on the operating parameters of transmitter 54 and the associated relay capabilities, the image could be transmitted anywhere in the world as in the case, for example, of a satellite transmitter or global wireless transmitter. Alternatively, ground based transmitter 54 may be coupled in a known manner to the Internet, whereupon image server 40 could be thereby be connected to any device which is also connected to the Internet in any number of different known manners (not shown). In one embodiment, image server 40 may include a modem and corresponding communication drivers to connect to the Internet via what is known in the art as a “dial-up” connection. In another embodiment, e.g. what is known in the art as a “direct” connection, image server 40 includes an Ethernet or similar hardware card to connect to a multi-user local-area network (LAN) which itself may be connected to the Internet via a high-speed gateway such as a Ti line, or the like. In further embodiments, image server 40 may be connected to the Internet using a cable modem or satellite Internet connectivity. In yet another illustrative embodiment, image server 40 may be coupled to Management Information System (MIS) 56 via interface 63. It will be understood that MISs as are well known to one skilled in the art, may be used to support the infrastructure of businesses and organizations such as an internal LAN, or the like as described above.

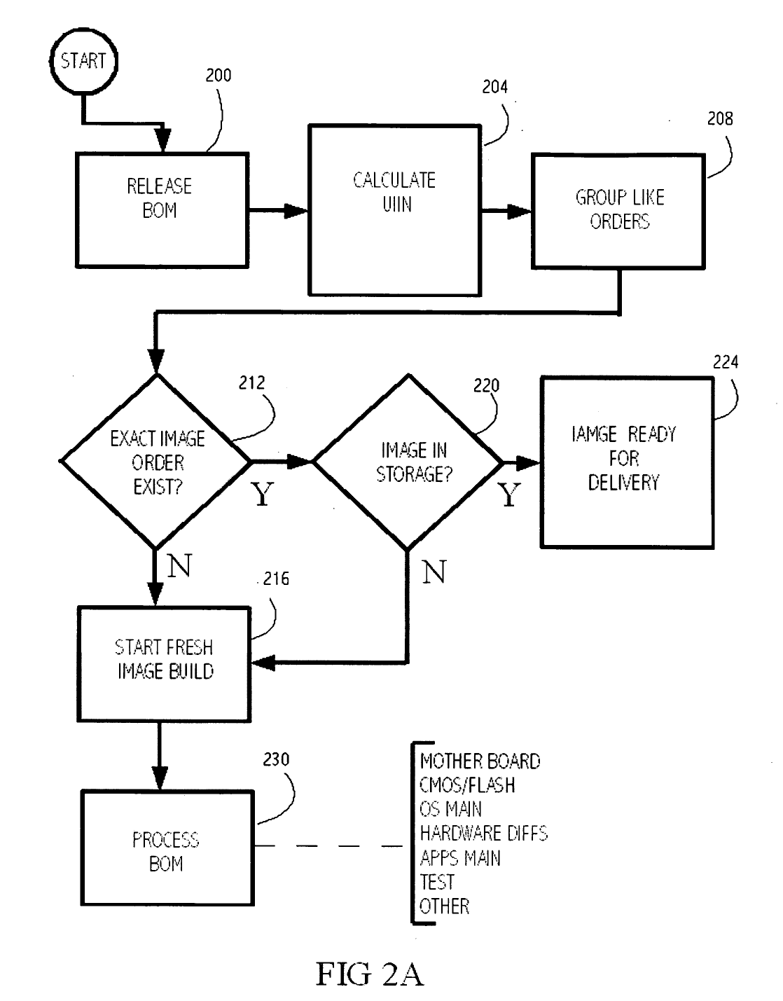

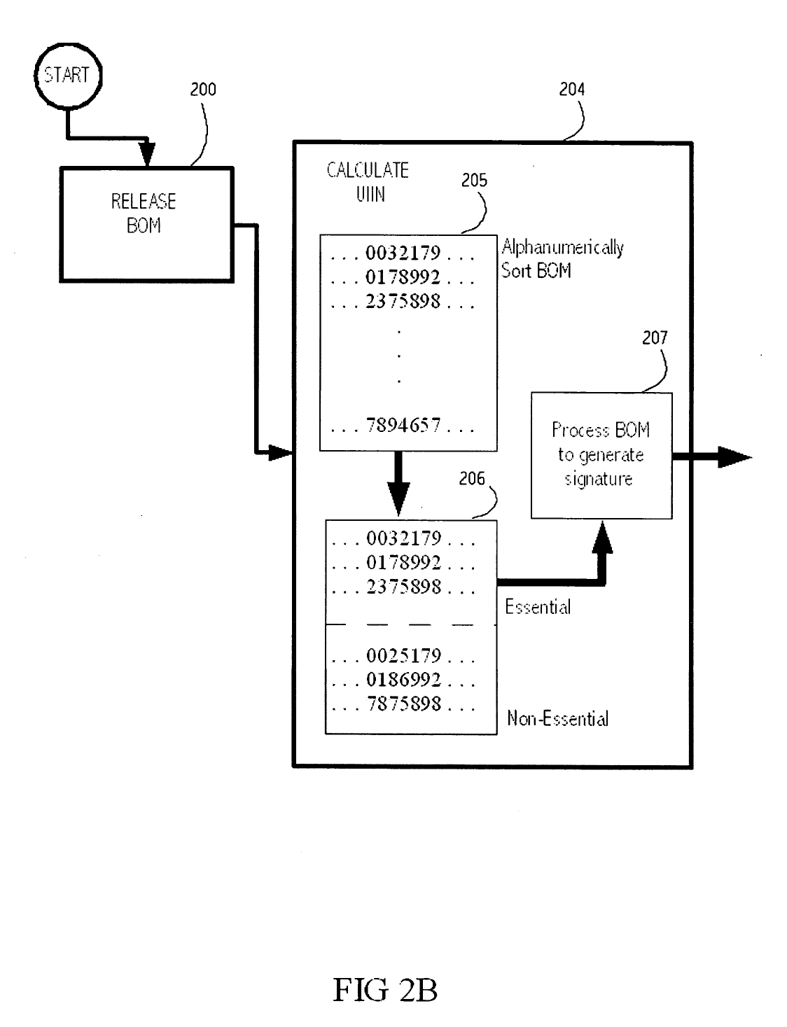

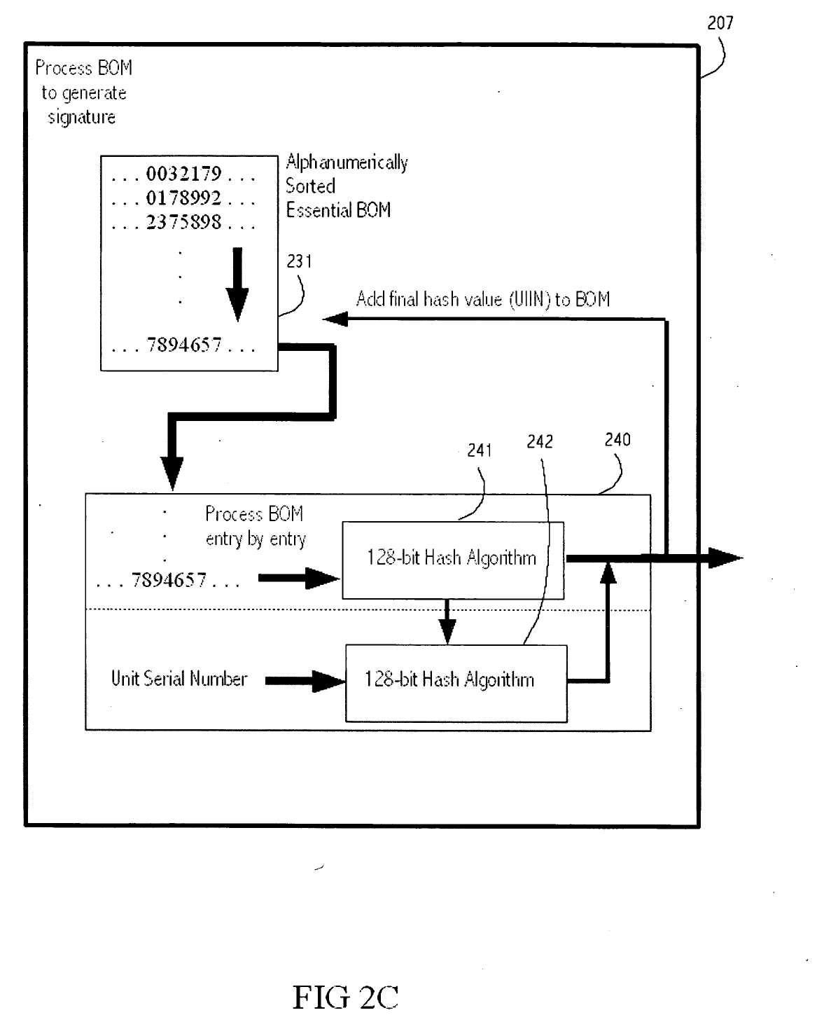

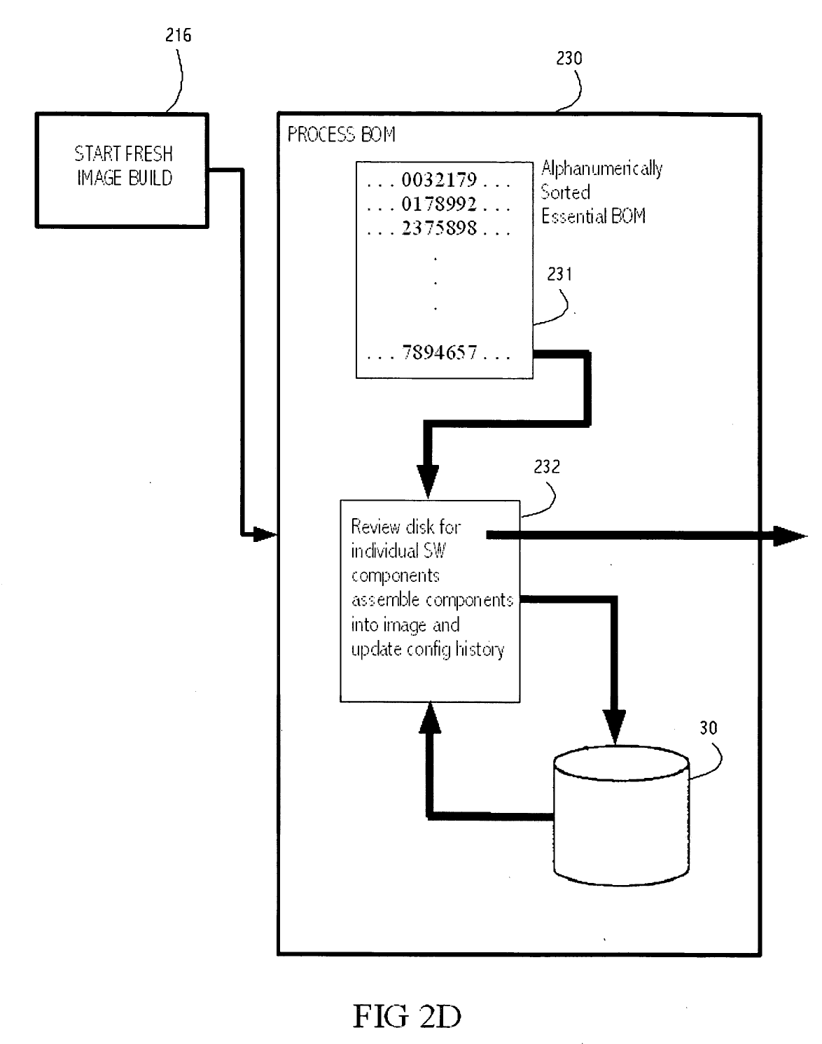

In accordance with various embodiments of the invention, image generation may proceed according to the exemplary process flow as illustrated in FIG. 2A. At the start of the process, in block 200, a BOM may be released, for example from order entry system 15. It should be noted that, as previously described, the BOM may be re-arranged or sorted in alphanumeric order as a way of normalizing the data entries, e.g. part numbers, such that data entry errors may be easily spotted and corrected. The part numbering format may preferably be in accordance with a manufacturer's internal part numbering system, such as, for example, the 7-digit part numbers used by Gateway 2000, Inc. which facilitates the substitution of different OEM parts from time to time for components in subassemblies having compatible functions. For example, a Toshiba DVD drive with an OEM part number SDM1712B might have an internal part number of 5500426. It is possible that the OEM part number would change without affecting the drive's specification under the existing internal number therefore the internal part number would remain the same. Alternatively, each different OEM number might be assigned an internal part number for BOM purposes. In either case, the BOM for image building purposes comprises a sorted list of component part numbers which include hardware and software components. It should further be noted that for image building purposes, part numbers may further be sorted into essential and non-essential parts for image building purposes as will be described in greater detail herein after.

Once the BOM is received into block 204, image builder 20 starts with the initial record and processes the BOM in a run length manner in its entirety, or alternatively in an entry by entry manner or a combination thereof, e.g. software BOM portion in its entirety and hardware BOM portion in its entirety, to generate a Unique Software Image Identification Number (USIIN) for the entire list or a portion thereof. It will be appreciated that in an effort to uniquely define each configuration as it is generated in the order process, the USIIN generation process can employ encoding so as to generate a unique signature, or key for the particular configuration. Such an encoding can be performed in several ways as will be described in greater detail herein. After encoding, the orders may then be grouped as in block 208 for greater efficiency. Once grouped, image builder 20 may compare USIINs as in block 212 to the configuration history, e.g. USIINs already in existence and possibly cached, for example, on storage device 30. If the configuration exists, then, as in block 220, a history count may be updated and a further check may be performed to determine if the USIIN is presently cached. One of skill in the art will appreciate that cache availability will be determined primarily by the frequency with which the USIIN appears in the image generation process. If an image corresponding to the USIIN is available in cache memory, for example, on storage device 30 or a portion thereof, the configuration may be flagged or indicated to be ready for delivery as in block 224, that is the image is available to be transferred to any one of the destination devices as previously described. If the USIIN is not available, then a fresh build is preferably initiated by image builder 20 as in block 216. It will be noted that as part of the process of building a fresh image corresponding to the configuration which has not been found on storage device 30, image builder 20 may preferably process the BOM as in block 230 to determine the hardware and software configuration and to find any possible baseline images on storage device 30 which can be used to create a fresh image corresponding to the desired configuration as will be described in greater detail hereinafter.

In order to effectively track images and software baselines it is important to accurately number different software configurations. Such configuration numbering is shown in FIG. 2B providing details associated with exemplary block 204 for calculating USIIN as previously described. When a BOM is released, it may be alphanumerically sorted, preferably in ascending order, in block 205 to increase the likelihood that any data entry errors will be immediately apparent as will be understood to those skilled in the art. The BOM may also be sorted in descending alphanumeric order. Before or after sorting, the BOM may be broken down into essential and non-essential portions in block 206, shown for illustrative purposes after alphanumeric sorting. It will be appreciated by one of skill in the art that the essential portion of the BOM includes any hardware or software having an impact on the generation of the image. Such components include but are not limited to software applications, software drivers, software configurable hardware devices, operating systems, registries, initialization files, libraries, and the like. It will further be appreciated that non-essential parts might include power plugs, mechanical enclosures or the like. Although such non-software impacting components may be deemed to be non-essential, to the extent that “smart” power plugs or the like exist or are developed, such smart components to the further extent that they are software controlled or software impacting, they can be considered essential in accordance with the present invention. After dividing the BOM into essential and non-essential portions, the essential portion may be used to process and generate a unique image identifier, e.g. the USIIN in block 207 as shown in greater detail in FIG. 2C.

Thus, as in block 231, the essential BOM may be sorted in ascending alphanumeric order and forwarded to block 240 for further processing. Block 240 contains blocks 241 and 242 for processing data associated with the essential BOM in accordance with a signature generating algorithm. It will be appreciated that several signature generating algorithms may be employed, such as a CRC generator or the like, however a 128-bit hash algorithm is preferred based on the attendant low probability of generating duplicate signatures for different BOM configurations. It will further be appreciated by those skilled in the art that the 128-bit hash algorithm may take an arbitrary length message, such as a typical 7-digit part number, and perform the hash in one of many known ways, generating a 128-bit “fingerprint” of the input message. Alternatively, the 7-bit part number may have zeros, or other padding characters or character patterns, appended and/or prepended thereto without departing from the invention. Thus, the BOM may be processed line-by-line in order to generate a 128 bit signature or Unique Image Identification Number (USIIN), corresponding to the software configuration associated with the image. The USIIN may be added to the BOM as a way for software configuration monitoring software and image generation and duplication software to identify exact image orders. If it is desired to create a unique identifier for the system plus the image, the unit serial number may optionally be hashed and combined as shown in block 242 with the USIIN to ensure unit level uniqueness.

If an exact image order, e.g. an image corresponding to the USIIN does not exist, as shown in FIG. 2D, a fresh image build may be started as in block 216. To begin the image build, the BOM which, as previously described, is preferably alphanumerically sorted in ascending order as in block 231. In block 232, the BOM may be scanned and software components found on, for example, storage device 30. It will be appreciated that in the process of scanning for software components, any updates, fixes or the like which are made available after ordering but before image building may be incorporated into the image. Thus, the software components may be assembled into a file format, e.g. the “image”, structured for streaming transfer onto, for example, a blank target hard disk. It will further be noted that the hard disk may be formatted so as to be able to receive the data transfer in a block write mode, that is, a mode where there is no concern for file allocation tables or the like, but rather raw block by block transfer. A typical block size for streaming transfer would be, for example, 512 bytes. As part of the construction of the image, a file allocation table (FAT) or the like is placed in a position so that it will be written in the customary location on the disk and contain the sectors or locations of files and components comprising image build. Such positioning of the FAT or the like, is important so that once the image is loaded onto the target system, the software components may be found by, for example, the processor, operating system or the like during normal operation. Once the image is built, it may be stored on storage device 30, preferably in a cache area and may be indexed using, for example, the USIIN.

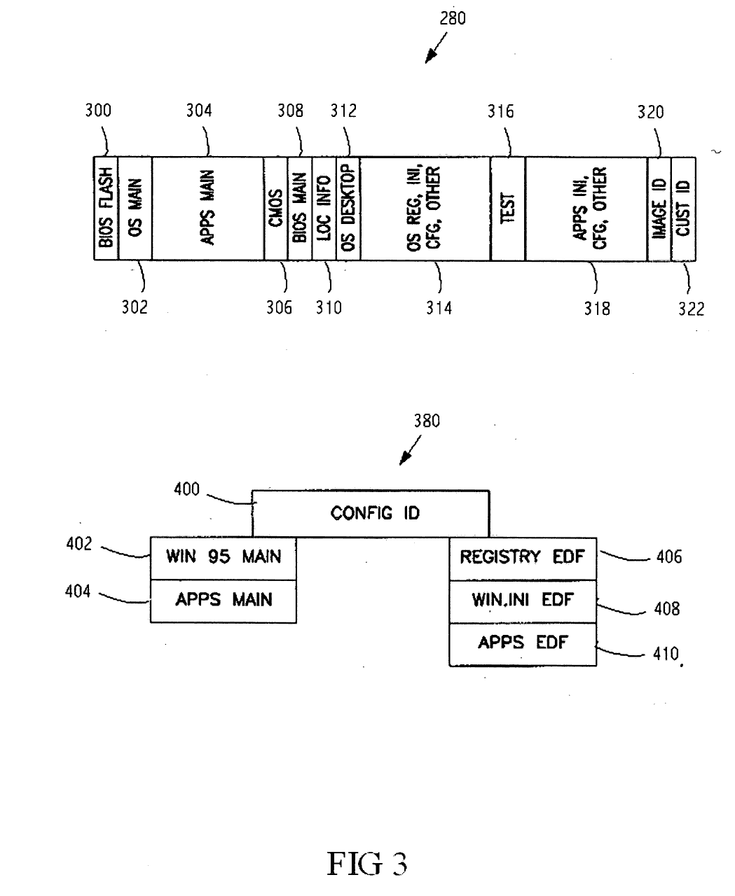

FIG. 3 illustrates an exemplary architecture associated with disk image 280 as created by image builder 20. As described, image builder 20 constructs image 280 according to a desired software configuration and delivers that image to a storage device 30 where it may be further distributed to other systems or to one or more target devices such as disks. While sections of disk image 280 appear in a particular order in FIG. 3, one skilled in the art will readily realize that other architectural embodiments of the image are possible. However, as described, certain components may require placement in a particular location to conform to system conventions. Thus, section 300 may preferably contains BIOS flash properties for controlling certain embedded I/O ports and devices. Section 302 may preferably contain the main operating system and section 304 may preferably contain program code, instructions, and support files, such as libraries, text files, ini files and the like, associated with main applications such as word processors, spread sheets, and the like.

Hardware characteristics associated with the target computer system receiving disk image 280 are preferably addressed by section 306 containing CMOS settings. Section 308 preferably includes main BIOS instructions, section 310 preferably contains location information such as the location of file segments, or the like, and section 312 contains desktop parameters for the main operating system. Section 314 contains information including, but not limited to the following: operating system registries, initialization files and related information, and configurations files. Section 316 preferably includes test information. Section 318 includes, but is not limited to the following: application-related initialization files and related information and configurations files. The last two sections preferably contain an identification of the specific image or USIIN 320, and customer ID 322, which is preferably a serial number or the like sufficient to identify the particular unit and thus the “customer”. It will be appreciated that USIIN 320 and customer ID 322 may allow for future reference to the particular configuration of the image, which is helpful for trouble shooting and also facilitates adding delta images to the previously delivered image in order to upgrade existing applications. It will further be appreciated that identification scheme 380 including CONFIG ID 400 may be used to provide a compact identification of the high level software configuration associated with the disk image structure. As can be seen, identification may be present corresponding to main software such as, for example, operating system 402 illustrated as Windows 95, and applications 404. Further identification may be included corresponding to edited dynamic files (EDF). More specifically, the identification scheme 380 includes a identification associated with the main high level software the desired image is built from and is important in creating the desired image or updates thereto. Once the software configuration associated with CONFIG ID 400 is identified, then the main files corresponding to operating system 402, e.g., Windows 95, and desired applications 404 also identified. Edited dynamic files may further be identified associated with registry settings 406, operating system initialization files 408, and application files 410.

It is believed that the unique image identifier of the present invention and many of its attendant advantages will be understood by the forgoing description. It is also believed that it will be apparent that various changes may be made in the form, construction and arrangement of the invention or components thereof without departing from the scope and spirit of the invention or without sacrificing all of its material advantages. The form herein before described being merely an explanatory embodiment thereof. It is the intention of the following claims to encompass and include such changes.

What is claimed is:

1. A method for identifying a software configuration in an image delivery system having a storage device, the method comprising:
processing a component list associated with a system to be built, the component list containing a essential portion and a non-essential portion,
performing a key generating function on the essential portion of the component list to generate a key associated with the software configuration, and
using the generated key to determine if the software configuration exists on the storage device.

2. The method of claim 1, further comprising the steps of:
transferring an image associated with the software configuration to one or more target devices if the essential component list associated with each of the one or more target devices produces the generated key when the key generating function is performed on the associated each essential component list, and
generating a new image associated with the software configuration if the essential component list associated with each of the one or more target devices fails to produce the generated key when the key generating function is performed on the associated each essential component list.

3. The method of claim 1, wherein the key generating function includes a 128-bit hash algorithm.

4. The method of claim 2, wherein the key generating function includes a 128-bit hash algorithm.

5. The method of claim 1, wherein the essential component list includes software-related components.

6. The method of claim 2, wherein the essential component list includes software-related components.

7. A method for identifying a software configuration in an image delivery system having a storage device, the method comprising:
generating a bill of materials associated with a target computer system from an order entry portion of the image delivery system,
dividing the bill of materials into an essential portion and a non-essential portion,
sorting at least the essential portion of the bill of materials into alphanumeric order,
performing a key generating function on the at least the essential portion of the bill of materials to generate a key associated with the software configuration, and
using the generated key to determine if the software configuration exists on the storage device.

8. The method of claim 7, further comprising the steps of:
transferring an image associated with the software configuration to one or more of the target computer system if the at least the essential portion of the bill of materials associated with each of the one or more of the target computer system produces the generated key when the key generating function is performed on the associated each at least essential portion of the bill of materials, and
generating a new image associated with the software configuration if the at least the essential portion of the bill of materials associated with the each of the one or more target computer system fails to produce the generated key when the key generating function is performed on the associated each at least essential portion of the bill of materials.

9. The method of claim 7, wherein the key generating function includes a 128-bit hash algorithm.

10. The method of claim 8, wherein the key generating function includes a 128-bit hash algorithm.

11. The method of claim 7, wherein the essential portion of the bill of materials includes software-related components.

12. The method of claim 8, wherein the essential portion of the bill of materials includes software-related components.

13. The method of claim 7, wherein the at least essential portion of the bill of materials is sorted into ascending alphanumeric sequence.

14. The method of claim 8, wherein the at least essential portion of the bill of materials is sorted into ascending alphanumeric sequence.

15. A method for identifying a software configuration in an image delivery system having a storage device, the method comprising:
generating a bill of materials associated with a target computer system from an order entry portion of the image delivery system,
sorting the bill of materials into alphanumeric order,
performing a key generating function on at least a portion of the bill of materials to generate a key associated with the software configuration, and
using the generated key to determine if the software configuration exists on the storage device.

16. The method of claim 15, further comprising the steps of:
transferring an image associated with the software configuration to one or more of the target computer system if the at least a portion of the bill of materials associated with each of the one or more of the target computer systems produces the generated key when the key generating function is performed on the associated each at least a portion of the bill of materials, and
generating a new image associated with the software configuration if the at least a portion of the bill of materials associated with the each of the one or more target computer system fails to produce the generated key when the key generating function is performed on the associated each at least a portion of the bill of materials.

17. The method of claim 15, wherein the key generating function includes a 128-bit hash algorithm.

18. The method of claim 16, wherein the key generating function includes a 128-bit hash algorithm.

19. The method of claim 15, wherein the essential component list includes software-related components.

20. The method of claim 16, wherein the essential component list includes software-related components.

21. The method of claim 15, wherein the bill of materials is sorted into ascending alphanumeric sequence.

22. The method of claim 16, wherein the bill of materials is sorted into ascending alphanumeric sequence.

23. A computerized system for identifying a software configuration for image delivery, the system comprising:
a processor,
a computer readable medium capable of being read by the processor, and
a plurality of computer instructions on the computer readable medium, the plurality of computer instructions executable by the processor, the plurality of computer instructions for causing the processor to:
generate a bill of materials associated with a target computer system from an order entry portion of the image delivery system,
sort the bill of materials into alphanumeric order,
perform a key generating function on at least a portion of the bill of materials to generate a key associated with the software configuration, and
using the generated key to determine if the software configuration exists on the storage device.

24. The computerized system of claim 23, wherein the instructions further cause the processor to:
transfer an image associated with the software configuration to one or more of the target computer system if the at least a portion of the bill of materials associated with each of the one or more of the target computer systems produces the generated key when the key generating function is performed on the associated each at least a portion of the bill of materials, and
generate a new image associated with the software configuration if the at least a portion of the bill of materials associated with the each of the one or more target computer system fails to produce the generated key when the key generating function is performed on the associated each at least a portion of the bill of materials.

25. The computerized system of claim 23, wherein the key generating function includes a 128-bit hash algorithm.

26. The computerized system of claim 24, wherein the key generating function includes a 128-bit hash algorithm.

27. The computerized system of claim 23, wherein the essential component list includes software-related components.

28. The computerized system of claim 24, wherein the essential component list includes software-related components.

29. The computerized system of claim 23, wherein the bill of materials is sorted into ascending alphanumeric sequence.

30. The computerized system of claim 24, wherein the bill of materials is sorted into ascending alphanumeric sequence.

31. A computerized system for identifying a software configuration for image delivery, the computerized system comprising:
a processor,
a computer readable medium capable of being read by the processor, and
a plurality of computer instructions on the computer readable medium, the plurality of computer instructions executable by the processor, the plurality of computer instructions for causing the processor to:
generate a bill of materials associated with a target computer system from an order entry portion of the image delivery system,
divide the bill of materials into an essential portion and a non-essential portion,
sort at least the essential portion of the bill of materials into alphanumeric order,
perform a key generating function on the at least the essential portion of the bill of materials to generate a key associated with the software configuration, and
use the generated key to determine if the software configuration exists on the storage device.

32. The computerized system of claim 31, wherein the instructions further cause the processor to:
transfer an image associated with the software configuration to one or more of the target computer system if the at least the essential portion of the bill of materials associated with each of the one or more of the target computer system produces the generated key when the key generating function is performed on the associated each at least essential portion of the bill of materials, and
generate a new image associated with the software configuration if the at least the essential portion of the bill of materials associated with the each of the one or more target computer system fails to produce the generated key when the key generating function is performed on the associated each at least essential portion of the bill of materials.

33. The computerized system of claim 31, wherein the key generating function includes a 128-bit hash algorithm.

34. The computerized system of claim 32, wherein the key generating function includes a 128-bit hash algorithm.

35. The computerized system of claim 31, wherein the essential component list includes software-related components.

36. The computerized system of claim 32, wherein the essential component list includes software-related components.

37. The computerized system of claim 31, wherein the at least essential portion of the bill of materials is sorted into ascending alphanumeric sequence.

38. The computerized system of claim 32, wherein the at least essential portion of the bill of materials is sorted into ascending alphanumeric sequence.

39. A computerized system for identifying a software configuration for image delivery, the computerized system comprising:
a processor,
a computer readable medium capable of being read by the processor, and
a plurality of computer instructions on the computer readable medium, the plurality of computer instructions executable by the processor, the plurality of computer instructions for causing the processor to:
process a component list associated with a system to be built, the component list containing a essential portion and a non-essential portion,
perform a key generating function on the essential portion of the component list to generate a key associated with the software configuration, and
use the generated key to determine if the software configuration exists on the storage device.

40. The computerized system of claim 39, wherein the instructions further cause the processor to:
transfer an image associated with the software configuration to one or more target devices if the essential component list associated with each of the one or more target devices produces the generated key when the key generating function is performed on the associated each essential component list, and
generate a new image associated with the software configuration if the essential component list associated with each of the one or more target devices fails to produce the generated key when the key generating function is performed on the associated each essential component list.

41. The computerized system of claim 39, wherein the key generating function includes a 128-bit hash algorithm.

42. The computerized system of claim 40, wherein the key generating function includes a 128-bit hash algorithm.

43. The computerized system of claim 39, wherein the essential component list includes software-related components.

44. The computerized system of claim 40, wherein the essential component list includes software-related components.
